(19) United States
(12) Patent Application Publication
(10) Pub. No.: US 2025/0038623 A1
(43) Pub. Date: Jan. 30, 2025

(54) METHOD FOR THE OPERATION OF AN ELECTRIC MACHINE

(71) Applicant: ZF Friedrichshafen AG, Friedrichshafen (DE)

(72) Inventors: Julian KAMPS, Friedrichshafen (DE); Luis AYALA, Markdorf (DE)

(21) Appl. No.: 18/770,814

(22) Filed: Jul. 12, 2024

(30) Foreign Application Priority Data
Jul. 27, 2023 (DE) 10 2023 207 157.6

(51) Int. Cl. H02K 11/00

(52) U.S. Cl. CPC H02K 11/0094

(57) ABSTRACT

A method for the operation of an electric machine, particularly of a motor vehicle, having a transmission device with a primary side, particularly a stationary primary side, an inductive exciter device and includes a secondary side particularly connected to a rotor of the electric machine, switch devices of the inductive exciter device being operated in a defined switching state with a defined switching frequency in order to transmit an electrical signal inductively from the primary side to the secondary side by the inductive exciter device. The inductive exciter device is operated between at least two switching states in a non-switching state in which switch devices of the inductive exciter device are not switched, in particular until a subsequent switching state.

### BACKGROUND OF THE INVENTION

### 1. Field of the Invention

The disclosure is directed to a method for the operation of an electric machine particularly of a motor vehicle, comprising a transmission device with a primary side, particularly a stationary primary side, having an inductive exciter device and comprising a secondary side particularly connected to a rotor of the electric machine. Switch devices of the inductive exciter device are operated in a defined switching state with a defined switching frequency in order to transmit an electrical signal inductively from the primary side to the secondary side by means of the inductive exciter device.

### 2. Description of Related Art

Methods for operating electric machines, particularly electric machines for motor vehicles, which have a transmission device with an inductive exciter device in order to transmit electrical signals from a primary side to a secondary side are known in principle from the prior art. Usually, a current is transmitted from the stationary primary side to the secondary side connected to the rotating rotor of the electric machine in order to be able to operate the electric machine.

In this respect, it is known that in different power states, for example, at different clock rates, various losses can occur in the transmission device, for example, through diode losses or switching losses. In this regard, it has been shown that while efficient operating points can be found, these operating points cannot always be occupied depending on the actual operating state of the electric machine, since the operation of the transmission device is ultimately dependent on the task required of the electric machine. For example, if partial load regions are occupied, the efficiency of the transmission device decreases compared to a more efficient operating point which, however, can possibly not be occupied by the electric machine because of its power requirements.

### SUMMARY OF THE INVENTION

It is an object of one aspect of the invention to provide a method for operating an electric machine which is improved over the prior art and in which the efficiency is improved, particularly in partial load regions.

As described, one aspect of the invention is directed to a method for operating an electric machine, particularly of a motor vehicle, which electric machine has a transmission device which has a primary side with an inductive exciter device and a secondary side which is connected, for example, to the rotor of the electric machine. Switch devices of the inductive exciter device are operated in a defined switching state with a defined switching frequency in order to transmit an electrical signal inductively from the primary side to the secondary side by means of the inductive exciter device. In other words, the switch devices of the exciter device are switched with the defined switching frequency in order to transmit the electrical signal. As has been described, the sampling rate which is determined by the times or time ratios in which the switch devices are opened and closed is given by the aimed-for operating state of the electric machine, for example, the torque to be outputted in the current state of the electric machine. In other words, the switch devices are alternately switched on and switched off during the switching state in order to generate the electrical signal which can subsequently be transmitted inductively from the primary side to the secondary side.

One aspect of the invention is based on the insight that the inductive exciter device is operated between at least two switching states in a non-switching state in which switch devices of the inductive exciter device are not switched in particular until a subsequent switching state. As described, the switch devices are alternately switched on and switched off in the switching state in order to generate the electrical signal to be transmitted. In the non-switching state which is carried out between two switching states, an alternating switching of this kind does not take place; rather the switch device of the primary side remains unswitched, particularly through several clock cycles. As a result, no signal is transmitted from the primary side to the secondary side in the non-switching state, but the electric machine nevertheless continues in operation for the duration of the non-switching state because the secondary side of the electric machine is fed by the comparatively large inductances provided therein, for example, the rotor inductance, and the current flow therethrough can also be maintained in the non-switching state.

Therefore, in an advantageous manner, it is not necessary to switch the switch devices in all operating states of the electric machine for generating the electrical signal which is to be inductively transmitted subsequently from the primary side to the secondary side. In particular, partial load regions, which are inefficient, can accordingly be prevented. Instead, the switching states and non-switching states can be divided up in such a way that a comparatively high efficiency can always be achieved during the inductive transmission of the electrical signal between the primary side and the secondary side. The non-switching state can accordingly also be understood as a “paused state” with reference to the operation of the switch device of the inductive transmission device. Therefore, in the non-switching state there are no switching states of the inductive exciter device, particularly of the switching devices thereof, and the electric machine nevertheless continues to operate; for instance, the electric machine also provides torque in the non-switching state.

Further, in the method described above, it can be provided that switching states and non-switching states are carried out alternately. In this embodiment form, it can be provided that a non-switching state is carried out between two switching states and, consequently, a switching state is carried out between two non-switching states. Alternatively, depending on the current operating state of the electric machine, for example, depending on what torque can be demanded, a plurality of switching states can also be carried out one next to the other or one after the other, for example, in a full load region. When the full load region is followed in turn by an operating region with comparatively decreased load demands, a non-switching state can in turn follow the switching state so that switching states and non-switching states are always carried out in turns. In this way, switching states and non-switching states can be carried out in an alternating manner in such a way that a non-switching state is carried out after every switching state and a switching state is carried out after every non-switching state. This is possible, for example, in a continuous operation in a partial load region.

Further, it can be provided in the method that the switch devices of the inductive exciter device are switched in a switching state for a first quantity of cycles and not switched in a non-switching state for a second quantity of cycles. As described, the non-switching state follows the switching state and, according to this configuration, the quantity of cycles or clock cycles can be freely selected in the at least one switching state and the at least one non-switching state.

Accordingly, the first quantity of cycles in the switching state results in that the switch devices of the inductive exciter device are switched and the electrical signal can accordingly be generated and inductively transmitted. In the non-switching state, the switch devices are not switched for the duration of the second quantity of cycles so that inductive transmission cannot take place but rather, as described, the feed of electrical energy proceeds from the inductances of the secondary side. The electrical energy transmitted from the primary side to the secondary side can finally be determined by setting the first quantity of cycles and the second quantity of cycles. In this way, it is possible for the primary side to be operated efficiently because the first quantity of cycles can be determined in such a way that the primary side can be operated in an efficient operating point. The balance which is necessary with respect to the actual operating state of the electric machine is accomplished through the non-switching state.

As described, the operation of the electric machine also continues to take place in the non-switching state. In this regard, it can be particularly provided that an inductance of the electric machine, particularly a rotor inductance, is utilized as current source for the operation of the electric machine in the at least one non-switching state. The inductance of the secondary side acts as energy storage or current source in the non-switching state, i.e., in the paused state. The secondary side, for example, the rotor, has comparatively large inductances, particularly in the range of several hundred mH. The inductance is used in the non-switching state to provide electrical energy so that the electric machine can also be operated in the non-switching state. In order that current continues to flow to the secondary side also in the non-switching state in which the switch devices of the inductive exciter device are not switched, the electric machine can continue to operate.

According to a further configuration of the method, it can be provided that a sampling rate is determined in the at least one switching state based on the at least one non-switching state. As has already been described, the preceding or following switching state, respectively, can be brought into another, more suitable operating point by carrying out the non-switching state. Therefore, in particular, the efficiency of the inductive exciter device can be improved because a suitable operating point can be occupied compared with an operation without non-switching state. In addition, no switching losses are generated on the part of the inductive exciter device while the non-switching state is carried out due to the absence of switching processes. The overall efficiency in the operation of the electric machine, particularly in partial load regions, is appreciably improved in this way.

The method can be further improved to the effect that a quantity of cycles during which the at least one non-switching state is carried out is variable. In this way it is possible, depending on the preceding and/or following switching state, to carry out the non-switching state for as long as is required for the optimal execution of the switching states. Accordingly, the non-switching state can finally be carried out as long as is required for the preceding and/or subsequent switching state to be carried out in a comparatively improved manner, particularly with respect to switching losses, for example, in order to occupy a comparatively higher-performing defined operating point.

According to a further development of the method, it can be provided that the quantity of cycles of the non-switching state is determined depending on a defined operating point of the inductive exciter device in the switching state. As has already been described, the switching state can be operated at a defined operating point, for example, an operating point that is optimized with respect to switching losses or the total losses for the operating state of the electric machine. For example, an operating point can be selected in which switching losses are minimized. Compared with an operation of the electric machine in which no non-switching state is carried out, it would be necessary to also carry out the switching state in partial load regions at inefficient operating points.

In comparison, the quantity of cycles of the non-switching state can be selected in just such a way that an operating point which is more efficient compared to an operation of the electric machine without non-switching state can be occupied in the preceding and/or following switching state. All in all, the same operating state of the electric machine is achieved; for one, the efficiency during the switching states can be increased by introducing the at least one non-switching state, since these switching states can be carried out in improved operating points, and no switching losses occur when carrying out the non-switching state so that the overall efficiency is increased.

The above-described operating point or defined operating point of the inductive exciter device can describe a defined load region, particularly a load region, which is optimized with respect to losses. For example, the defined operating point can be selected in such a way that switching losses or diode losses, transmission losses and the like are as low as possible. Such operating points can be stored or calibrated in a table, for example, so that operating points suitable for particular operating states of the electric machine can be predetermined. The operation of the primary side can accordingly always be carried out at efficient operating points, and a balance between the electrical signal which is outputted in the efficient operating point and the electrical signal which would be required for the actual operating state of the electric machine is achieved by carrying out the non-switching state. Accordingly, in particular, inefficient partial load regions on the part of the transmission device can be avoided or completely prevented.

In addition to the method, one aspect of the invention is directed to an inductive transmission device for an electric machine of a motor vehicle, which transmission device has a primary side, particularly stationary primary side, having an inductive exciter device and has a secondary side particularly connected to a rotor of the electric machine, wherein switch devices of the inductive exciter device are operable in a defined switching state with a defined switching frequency in order to transmit an electrical signal inductively from the primary side to the secondary side by the inductive exciter device, the inductive exciter device being formed between at least two switching states for operating in a non-switching state in which switch devices of the inductive exciter device are not switched particularly until a subsequent switching state.

One aspect of the invention is further directed to an electric drive arrangement which comprises an electric machine and such an inductive transmission device. The invention is further directed to an axle drive comprising an above-described inductive transmission device and/or an above-described electric drive arrangement. The invention is further directed to a motor vehicle which has an above-described inductive transmission device and/or an above-described electric drive arrangement and/or an above-described axle drive.

All of the advantages, details and features which have been described with reference to the method are entirely transferable to the inductive transmission device, the electric drive arrangement, the axle drive and the motor vehicle. The inductive transmission device is configured in particular to carry out the above-described method.

### BRIEF DESCRIPTION OF THE DRAWINGS

The invention will be described in the following referring to embodiment examples shown in the figures. The figures are schematic depictions and show:

FIG. 1 is a schematic view of the electric machine with a transmission device; and

FIG. 2 is a schematic view of an operation of the transmission device of the electric machine from FIG. 1.

### DETAILED DESCRIPTION OF THE PRESENTLY PREFERRED EMBODIMENTS

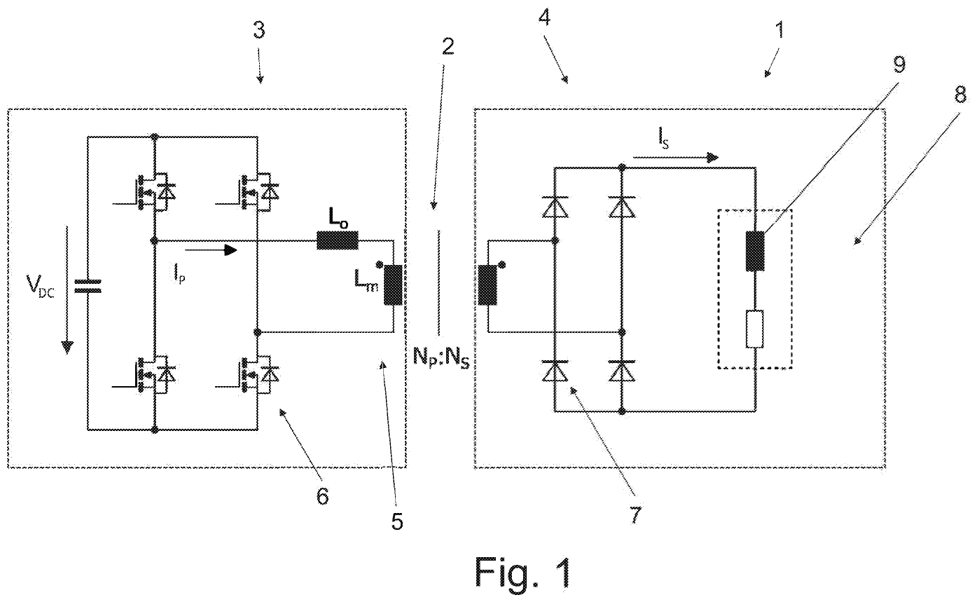

FIG. 1 is a schematic view of an electric machine 1 comprising a transmission device 2 which has a primary side 3 and a secondary side 4. The primary side 3 has an inductive exciter device 5 configured to transmit an electrical signal inductively from the primary side 3 to the secondary side 4. To this end, a plurality of switch devices 6 are provided on the part of the primary side 3 and on the part of the inductive exciter device 5, respectively, which switch devices 6 can be operated based on a defined switching frequency in order to generate the electrical signal, which is subsequently inductively transmitted from the primary side 3 to the secondary side 4. On the secondary side 4, the transmitted electrical signal is rectified, for example, by a rectifier device 7, and is fed to a component of the electric machine 1, for example, a rotor 8. The rotor 8 can have a plurality of rotor windings, for example. A rotor inductance 9 is depicted as proxy image.

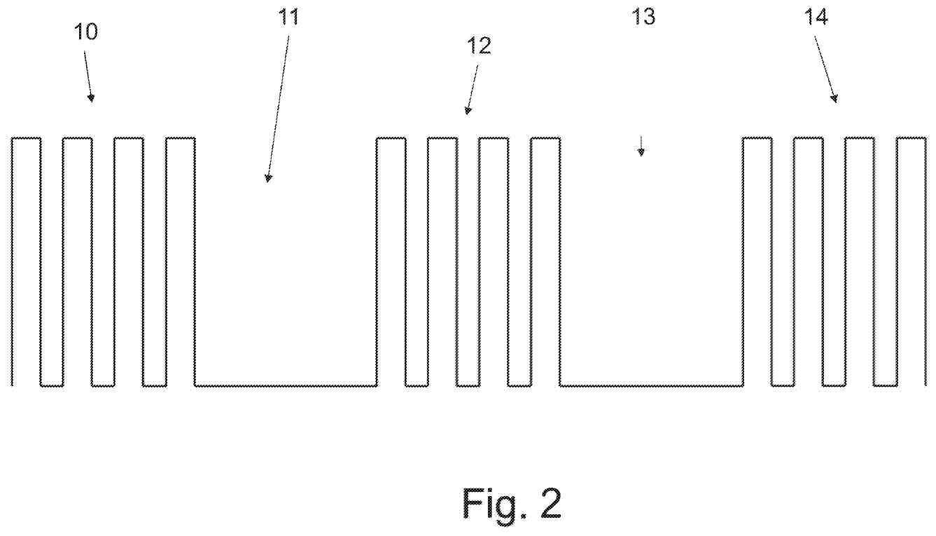

Depending on the power requirements from the electric machine 1 side, the electrical signal can, in principle, be generated and transmitted from the primary side 3 to the secondary side 4. In order to improve efficiency in the operation of the transmission device 2, the transmission device 2 is not continuously operated during operation of the electric machine 1 in a switching state in which the switch devices 6 are switched, but rather the operation is carried out using non-switching states as is illustrated in FIG. 2.

FIG. 2 shows individual switching cycles or clock cycles, which are carried out consecutively and in which corresponding switching signals of the switch devices 6 of the inductive exciter device 5 are outputted. It is shown purely by way of example that a switching state 10 in which the switch devices 6 are switched is carried out at the start. The duty cycle, i.e., the ratio between switching on and switching off the switch devices 6, is determined as a function of the actual operating state of the electric machine 1, for example, a torque demand. In particular, the transmission device 2 can be operated in an operating point which is efficient for the transmission device 2 and which, for example, lies above the operating point required for the operation of the electric machine 1. In the more efficient operating point, the overall efficiency can be improved in that corresponding diode losses, switching losses, transmission losses and the like can be minimized. In order to compensate for the deviation between the defined operating point and an operating point required for the actual operating state, a non-switching state 11 is carried out after the switching state 10.

In the non-switching state 11, the switching devices 6 of the inductive exciter device 5 are not switched, i.e., the non-switching state 11 is carried out in the absence of switching processes. Accordingly, in addition to the possibility of occupying an efficient operating point in the preceding switching state 10, the losses in the non-switching state 11 are further reduced because no switching processes are carried out in this state. The non-switching state 11 is followed in turn by a switching state 12 which, for example, in a continuous operation, can correspond to switching state 10 or may deviate therefrom corresponding to another torque demand of the electric machine 1. The switching state 12 can be followed in turn by a non-switching state 13 and the latter can be followed by a further switching state 14. The method can proceed correspondingly.

In principle, the duration and quantity of cycles of switching states 10, 12, 14 and non-switching states 11, 13, respectively, can be freely selected such that the non-switching states 11, 13 can also be carried out for different durations with respect to one another, i.e., for different quantities of cycles. As has been described, the operation of the electric machine 1 proceeds during the execution of the non-switching state 11, 13, since the flow of current to the secondary side 4 is then taken over by the rotor inductance 9, which functions as current source or as energy storage in the non-switching state 11, 13. At the end of the non-switching state 11, 13, the operation continues again in the switching state 10, 12, 14 in that the electrical signal is transmitted from the primary side 3 to the secondary side 4 by the inductive exciter device 5.

In particular, the electric machine 1 can be associated with an electric drive arrangement, particularly for a motor vehicle, or component of such a drive arrangement. The electric drive arrangement can be used, for example, for an electric axle drive and may constitute a component part thereof. Consequently, a motor vehicle can have the described transmission device 2 and the electric machine 1 or a drive arrangement of this kind or an axle drive of this kind. All of the details, advantages and features described in the individual embodiment examples are combinable, interchangeable and transferable to one another in any manner. In particular, the method can be carried out with the inductive transmission device 2.

Thus, while there have shown and described and pointed out fundamental novel features of the invention as applied to a preferred aspect thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A method for operation of an electric machine of a motor vehicle, having a transmission device with a primary side, configured as a stationary primary side, an inductive exciter device, and a secondary side connected to a rotor of the electric machine, comprising:
operating switch devices of the inductive exciter device in a defined switching state with a defined switching frequency to transmit an electrical signal inductively from the primary side to the secondary side by the inductive exciter device; and
operating the inductive exciter device between at least two switching states in at least one non-switching state in which switch devices of the inductive exciter device are not switched, until a subsequent switching state.

2. The method according to claim 1, wherein switching states and the at least one non-switching states are carried out alternately.

3. The method according to claim 1, wherein the switch devices of the inductive exciter device are switched in a switching state for a first quantity of cycles and not switched in a non-switching state for a second quantity of cycles.

4. The method according to claim 1, wherein an inductance of the electric machine, which is a rotor inductance, is utilized as a current source for operation of the electric machine in the at least one non-switching state.

5. The method according to claim 1, wherein a sampling rate is determined in the at least one switching state based on the at least one non-switching state.

6. The method according to claim 1, wherein a quantity of cycles during which the at least one non-switching state is carried out is variable.

7. The method according to claim 6, wherein the quantity of cycles of the non-switching state is determined depending on a defined operating point of the inductive exciter device in the switching state.

8. The method according to claim 7, wherein the defined operating point is a defined load region, which is optimized with respect to losses.

9. An inductive transmission device for an electric machine of a motor vehicle, which transmission device comprising:
a primary side, which is a stationary primary side;
an inductive exciter device;
a secondary side connected to a rotor of the electric machine; and
switch devices of the inductive exciter device that are operable in a defined switching state with a defined switching frequency to transmit an electrical signal inductively from the primary side to the secondary side by the inductive exciter device,
wherein the inductive exciter device is formed between at least two switching states for operating in a non-switching state in which switch devices of the inductive exciter device are not switched until a subsequent switching state.

10. An electric drive arrangement comprising:
an electric machine; and
an inductive transmission device comprising:
a primary side, which is a stationary primary side;
an inductive exciter device;
a secondary side connected to a rotor of the electric machine; and
switch devices of the inductive exciter device that are operable in a defined switching state with a defined switching frequency to transmit an electrical signal inductively from the primary side to the secondary side by the inductive exciter device,
wherein the inductive exciter device is formed between at least two switching states for operating in a non-switching state in which switch devices of the inductive exciter device are not switched until a subsequent switching state.

11. Axle drive comprising:
an inductive transmission device comprising:
a primary side, which is a stationary primary side;
an inductive exciter device;
a secondary side connected to a rotor of an electric machine; and
switch devices of the inductive exciter device that are operable in a defined switching state with a defined switching frequency to transmit an electrical signal inductively from the primary side to the secondary side by the inductive exciter device,
wherein the inductive exciter device is formed between at least two switching states for operating in a non-switching state in which switch devices of the inductive exciter device are not switched until a subsequent switching state.

12. A motor vehicle comprising:
an inductive transmission device comprising:
a primary side, which is a stationary primary side;
an inductive exciter device;
a secondary side connected to a rotor of an electric machine; and
switch devices of the inductive exciter device that are operable in a defined switching state with a defined switching frequency to transmit an electrical signal inductively from the primary side to the secondary side by the inductive exciter device,
wherein the inductive exciter device is formed between at least two switching states for operating in a non-switching state in which switch devices of the inductive exciter device are not switched until a subsequent switching state.
